(19) United States
(12) Patent Application Publication
(10) Pub. No.: US 2013/0093191 A1
(43) Pub. Date: Apr. 18, 2013

(54) VERTICAL AXIS WIND TURBINE

(71) Applicant: Krzysztof Janowski, Lodz (PL)

(72) Inventor: Krzysztof Janowski, Lodz (PL)

(73) Assignee: TELBITPHU, IWONA JANOWSKA, Lodz (PL)

(21) Appl. No.: 13/703,498

(22) PCT Filed: Jul. 12, 2011
(86) PCT No.: PCT/PL11/00072

§ 371 Date: Dec. 11, 2012

(30) Foreign Application Priority Data
Jul. 16, 2010 (PL) P.391861

(51) Int. Cl. F03D 11/00

(52) U.S. Cl. CPC F03D 11/00
USPC 290/55

(57) ABSTRACT

A wind turbine comprising a vertical axis rotor in which working blades are fastened to top and lower mount placed horizontally and separates elements of rotor (3) are connected to metal carrying arms placed horizontally (4) on a central vertical axis (5), including three blades (6) rotating around central axis (5) and in the sectional view having open airscrew profile along overall length. In the central part of the rotor there is a mean controlling airflow (7) covered from top and bottom with covers protecting the elements of construction from atmospheric effects (8) as well as improving its aerodynamic properties. The covers are fixed to mount disks (9) mounted in a distance “h” from each other, to which arms of supporting structure (4) are secured.

The invention relates to the wind turbine which includes a vertical axis rotor mounted on a mast.

The rotors of vertical axis wind turbines are commonly known as Savonius, Drrieux as well as Jackson-type rotors. A number of modifications of said classical solutions are known.

The wind turbine mounted on a mast with horizontal axis rotor as well as equipped with radially mounted blades shifted in sleeves ended with cams is known from polish patent description no. 162 648. Energy is transmitted to a drive shaft connected over transmission case to rotational vertical shaft which is mounted on a mast and connected to generator.

Previous projects of wind turbine rotor are known from polish patent descriptions no 168 652 and no. 176 172 as well as from patent application no. 381 110. This projects include vertical axis rotor, though in patent no. 168 652 the rotor has a segment construction consisting of at least two airfoils and every segment has finned structure, which side surface is a section of a solid similar to hyperboloid. The wind engine described in patent application no. 381 110 consists of cylinder shape tower with vertical axis rotor mounted on the top, comprising rotationally simple secured in bearings three blades. The blades have symmetric aerodynamic profile across vertical section, similar to plane wing construction. Anemoscope controls the rotor, though control gear can be started mechanically, hydraulically as well as pneumatically.

The patent application PCT no. WO/2006/119922 describes a system of vertical axis turbine rotational speed controlling facilities together with the said turbine construction. Speed controlling system applied enables to regulate the turbine running during strong winds, whereas doesn't influence the fundamental feature of vertical axis rotor, allowing to run the rotor during relatively slight wind.

The previous projects of wind turbine rotor are known from patent application in the frame of PCT procedure no. WO 2009/024714, WO 2009/036713 and WO 2009/072116. The patent application JP 58057082 describes a wind turbine which is two-way pneumatic turbine of axial flow. Said solutions as well as other vertical axis rotor applications emphasize the advantages of said construction. The advantages of said construction are as follows: high efficiency when there is both strong and slight wind, relatively small size, lack of necessity for high tower construction to secure the horizontal axis rotor blades. Quiet running is a very important feature distinguishing this kind of rotor, unlike the horizontal axis rotors, in which the airscrew blades are moving with different speed along their length. Often the speed at the end of blades is higher than speed of the wind, what generates a lot of noise.

Subject matter of the invention is a segment wind turbine equipped with vertical axis rotor or rotors mounted on a segment open metal tower. The invention also relates to shape of rotor blades and its structural component optimization in order to improve aerodynamic efficiency of this installation, which should provide maximum wind energy collection. The construction of a rotor and a turbine should provide strength of the installation and safety of its running.

Idea of the invention consists in wind turbine which is equipped with vertical axis rotor, which metal carrying arms are placed horizontally on a central vertical axis and are connected to three blades rotating around the central axis. The blades along their length have got half-open wing profile. In the central part of a rotor there is a device controlling the airflow covered from top and bottom with a cover protecting the construction elements from atmospheric effects, which main task is to improve aerodynamic qualities of the installation.

The element controlling the airflow, being a part of the rotor, is a hexagonal prism with crowned and concave walls, which are circular sector of a radius r=950 mm, arranged alternately generating three symmetric fields, in which crowned element is 46° and 10° of a circle as well as concave element which is 64° of a circle. The angle 10° is the maximal wing deflection angle relative to stator.

Rotating blade has half-open wing shape, in which straight element is directed toward a rotor axis while half-open element being a circular sector is pointed outside the rotor. Both elements in frontal part of a wing are semicircle bonding device of a radius r=136.6 mm.

Shape and overall dimensions of a stator as well as placing the blades and shaping them properly allowed obtaining the highest aerodynamic efficiency of the installation, which should provide maximum wind energy collection. At the same time rotor and turbine construction provides strength of the construction and safety of its running.

Wind turbine can be equipped with vertical axis rotor or rotors mounted on segment, open metal tower secured to the ground. Placing the device on a tower of a plain and modular construction allows obtaining the installation distinguished by high functionality and universal applications. Turbine can be equipped with up to three rotors.

The advantage of said wind turbine according to the invention is low speed wind of the order of 2,0 m/s uses, running in variable atmospheric conditions both at low and strong wind as well as silent running which can have deciding meaning when finding location. Modular construction allows getting installations of different power on the basis of one turbine.

The subject matter of the invention is presented in the following drawings in which:

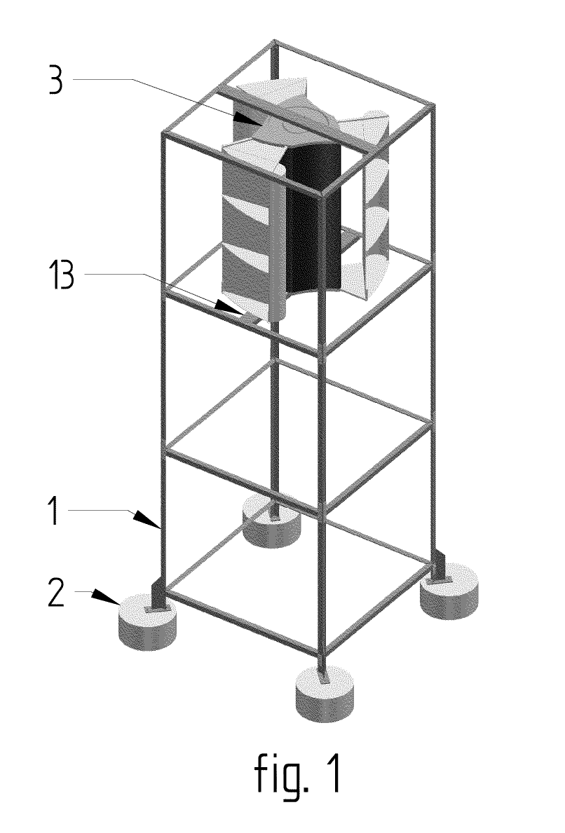

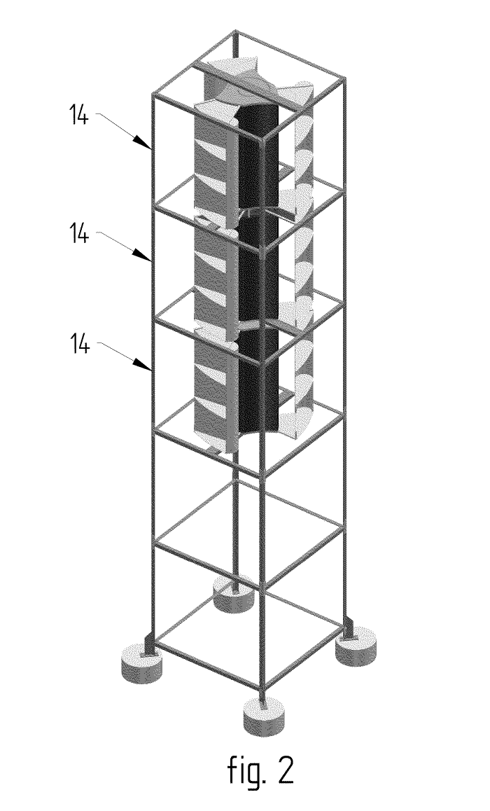

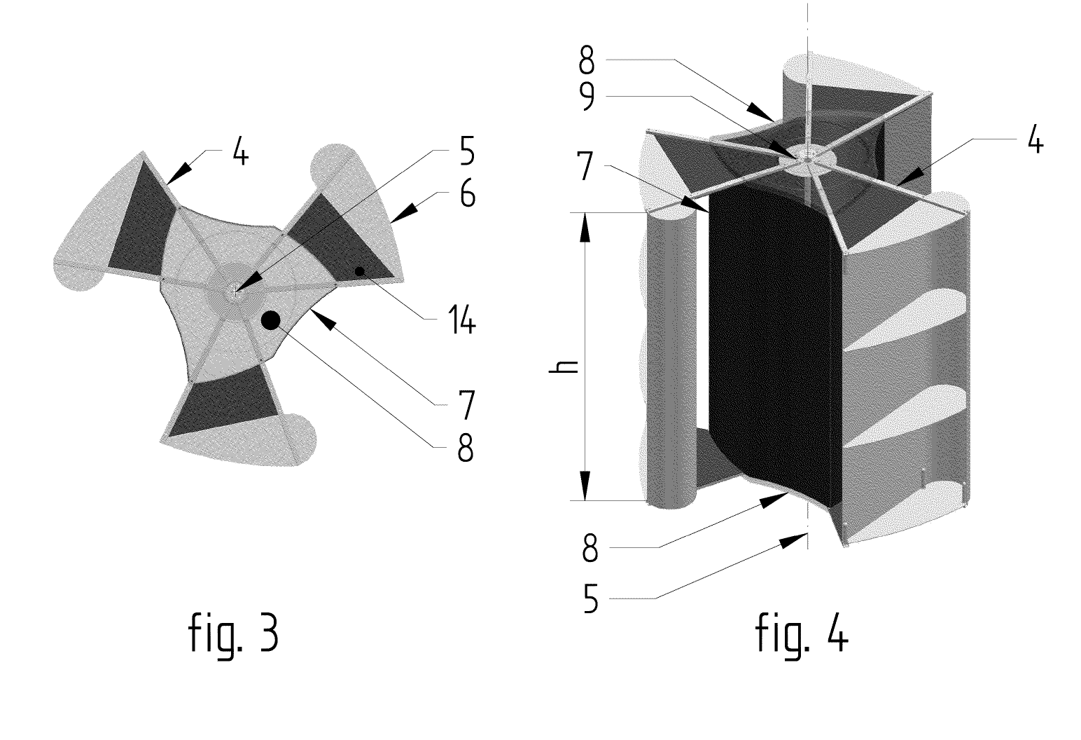

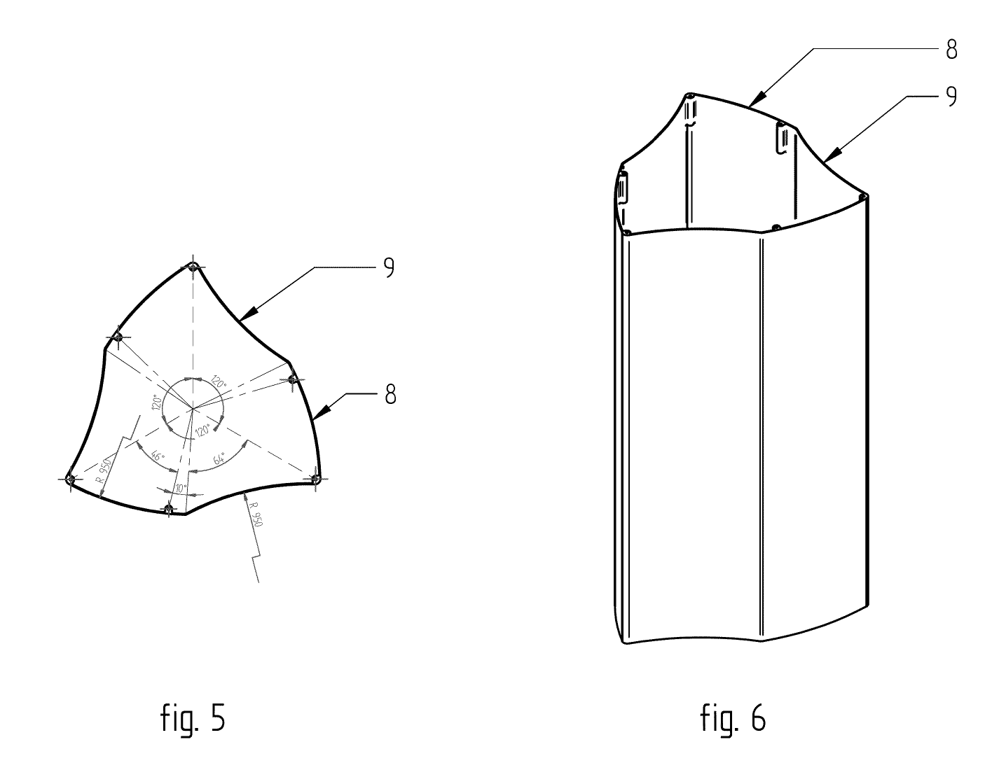

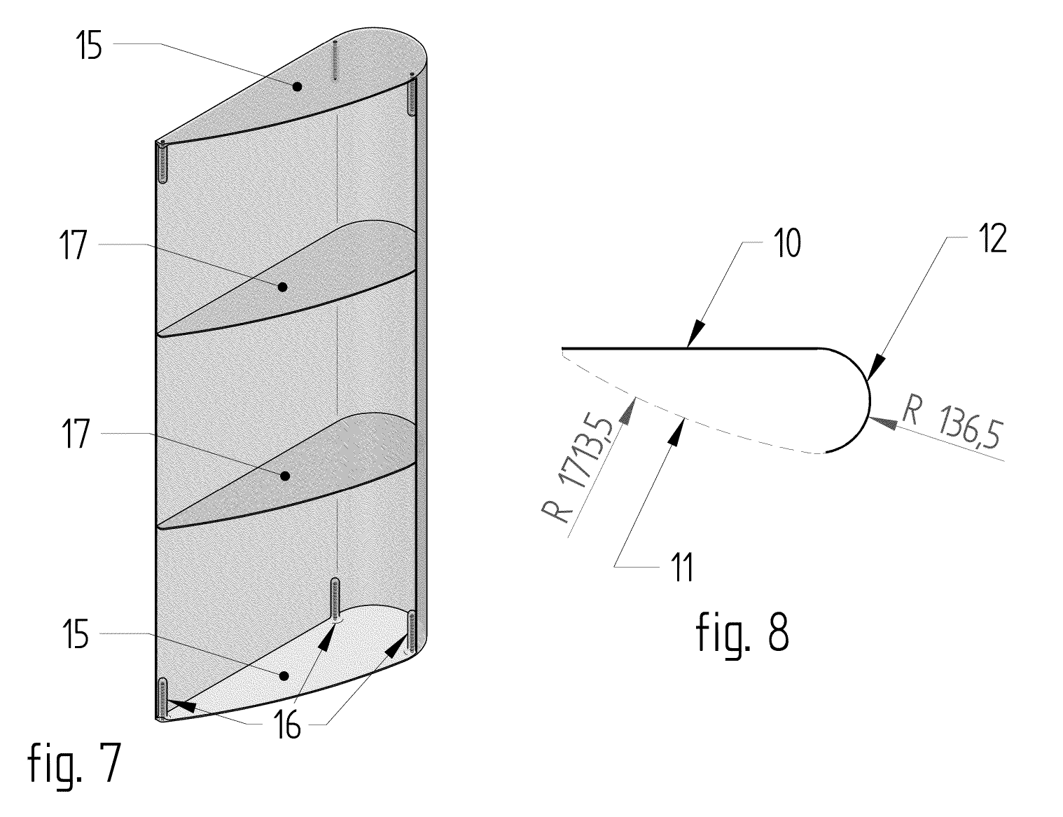

FIG. 1 is a pictorial side view of a wind turbine with one rotor. FIG. 2 is a pictorial view of a turbine with three rotors. FIG. 3 is a top plan view of the turbine rotor. FIG. 4 is a side view of the rotor. FIG. 5 is a top plan view of control mean, while FIG. 6 illustrates a pictorial view of a control mean for controlling airflow. FIG. 7 is a pictorial view of a rotating blade, while FIG. 8 is a sectional view taken on line A-A of this part.

The rotor of a vertical axis wind turbine shown in FIG. 3 and FIG. 4 consists of a control mean for controlling airflow 7 in the shape of hexagonal prism, which is covered from top and bottom with covers 8 protecting the elements of construction from atmospheric effects. Said elements are connected to mount disks 9 mounted in a distance “h” from each other.

Three blades in the shape of aerodynamic half-open airscrew 6 rotating around the central axis 5 are the base elements of the rotor. The covers 14 which are placed between the stator and rotor blades 6 from top and bottom of the installation have two-fold meaning. They make the airflow oriented and protect the installation from influence of atmospheric effects. The said solution takes advantage of pushing and puling force of the wind.

The mean controlling the airflow 7 shown in FIG. 5 and FIG. 6 is a hexagonal prism with convex 8 and concave 9 walls, which are circular sector of radius r=950 mm, arranged alternately and generating three symmetric fields, in which crowned element is 46° and 10° of a circle as well as concave element which is 64° of a circle.

The rotating blade 6 shown in FIG. 7 and FIG. 8 is a half-open airscrew, in which plain element is directed toward a rotor axis 10, while half-open element being a circular sector of a radius r=1713,5 mm is pointed outwardly from the rotor 11. Both elements in frontal part of a wing are semicircle bonding device of a radius r=136.6 mm 12. The blade is headed from top and bottom with en element 15 which shape results from blade intersection. Heading elements are connected to the blades through clamping screws 16 shown in FIG. 7. Additionally inside the stator two elements strengthening the blade construction 17 are installed, which shape results from blade intersection.

The wind turbine—FIG. 1 consists of metal open tower 1 which is rectangular prism. Said construction is a truss, in which cross-bars 13 are to fasten rotor or rotors depending on plant rating needs. The whole is mounted in concrete pillars 2 fixed in the ground. The solution shown in FIG. 2 illustrates opportunities of joining several rotors from 1 to 3 placed on a mast over each other in separate segments 14, which allows obtaining more power with constant operational safety.

Presented installation can be combined to form a wind farm. The power of turbine, selected for illustration, with one rotor which is 1880 mm in diameter and with 1866 mm high working airfoil, is 1,6 kW, when speed of wind is 6,5 m/s. 6,0 KW is the rated power of the system when three rotors are installed.

1. Wind turbine with vertical axis rotor, in which working blades are fastened to top and bottom mount placed horizontally, distinguished by separates elements of rotor (3) are connected to metal carrying arms placed horizontally (4) on a central vertical axis (5), including three blades (6) which rotate around central axis (5) and in the sectional view have open airscrew profile along the overall length, while in the center there is a mean controlling airflow covered from top and bottom with covers protecting the elements of construction from atmospheric effects (8) as well as improving aerodynamic properties of said rotor, which are fixed to mount disks (9) mounted in a distance “h” from each other, and to which arms of supporting structure are secured.

2. The turbine of claim 1, distinguished by the mean controlling the airflow (7) which is hexagonal prism with convex (8) and concave (9) walls which are circular sector arranged alternately and generating three symmetric fields, in which convex element is 46° and 10° of a circle, while concave element is 64° of a circle.

3. The turbine of claim 1, distinguished by half-open airscrew shape of the rotating blade (6) of said rotor, in which the plain element is directed toward the rotor axis (10), while half-open element being a circular sector is pointed outwardly from the rotor (11), and both elements in frontal part of the wing are semicircle bonding device of a radius r=136,5 mm (12).

4. The turbine of claim 1, distinguished by segmented open tower (1) of rectangular prism shape, in which said turbine is mounted, founded on concrete pillars (2) fixed in the ground.
